(19) United States
(12) Patent Application Publication
(10) Pub. No.: US 2007/0160768 A1
(43) Pub. Date: Jul. 12, 2007

(54) Pipeline-straddling protective barrier coating

(75) Inventors: Thomas S. Ohnstad, Salem, OR (US); Russell A. Monk, Salem, OR (US)

Correspondence Address: ROBERT D. VARITZ, P.C., 4915 SE 33RD PLACE, PORTLAND, OR, 97202, US

(73) Assignee: High Impact Technology, L.L.C.

(21) Appl. No.: 11/544,884

(22) Filed: Oct. 8, 2006

Related U.S. Application Data
(60) Provisional application No. 60/726,417, filed on Oct. 12, 2005.

(51) Int. Cl. B05D 1/02; B05C 5/00

(52) U.S. Cl. 427/421.1; 118/323

(57) ABSTRACT

A traveling pipeline straddle coater for spray-applying an anti-ballistic threat-diminishing, protective barrier coating to the outside of an elongate, ground-following petroleum-product pipeline. The straddle-coater includes a straddle frame which is clearance-positionable over such a pipeline, ground-traveling support structure supporting the frame for movement over the ground along the pipeline, canopy structure mounted on the frame for covering a frame-straddled length of the pipeline, and spray structure carried on the frame inside the canopy structure for spraying barrier-coating material onto the outside of the pipeline. The related method of the invention includes straddling a pipeline with a ground-traveling spray-coating apparatus, advancing the spray-coating apparatus progressively along that pipeline, and while so advancing, spray coating the pipeline with protective barrier-coating material.

### CROSS REFERENCE TO RELATED APPLICATION

This application claims priority to prior-filed, currently pending U.S. Provisional patent application, Ser. No. 60/726,417, filed Oct. 12, 2005, for “Pipeline-Straddle Barrier Coating”. The entire disclosure content of that provisional patent application is hereby incorporated herein by reference.

### BACKGROUND AND SUMMARY OF THE INVENTION

This invention relates to a unique structure, and to an associated methodology, for combining one or more protective anti-ballistic barrier coating(s) as layers onto an above-ground, liquid-petroleum-product-carrying pipeline, which extends in a highly exposed condition for long distances over the ground. In particular, the invention focuses attention on applying to the outside of such a pipeline one or more threat-diminishing, anti-ballistic, protective barrier coating materials aimed at providing the pipeline with an exterior, self-sealing, anti-puncture-leak coating. In a modified form of the invention, the invention further focuses on including an overlayer which functions in a related manner to provide fire suppression.

The invention recognizes the presence of a growing damage threat to exposed petroleum-product pipelines—threats aimed at creating significant liquid leaks followed by a naturally occurring, or purposely induced, catastrophic fire. This threatening condition, for example, exists currently in several locations and zones in the world where combatants are engaged in battles in areas where such over-the-ground exposed pipelines exist. The invention is also clearly very useful with regard to elongate pipelines which may not be situated in such a combat zone.

In accordance with the invention, what is proposed, structurally, is a traveling pipeline straddle-coater designed nominally for spray-applying a threat-diminishing, anti-ballistic barrier coating to the outside of an elongate, ground-following petroleum-product pipeline, with this straddle-coater including: (a) a straddle frame which is clearance-positionable over such a pipeline; (b) ground-traveling support structure supporting the travel frame for movement over the ground along the pipeline, under circumstances with the straddle frame positioned over that pipeline; (c) canopy structure mounted on the straddle frame for covering a frame-straddled length of such a pipeline; and (d) barrier-coating spray structure which is carried on the straddle frame inside the canopy structure, and which is operable to spray barrier-coating material onto the outside of such a canopy-received pipeline length. The invention also contemplates the use of a motion-producing instrumentality which creates either a substantially completely self-contained, self-propelled vehicle, or which operates in an external fashion, as by towing, to produce straddle-frame motion and travel along a pipeline.

From a methodologic point of view, the invention offered hereby involves a method of spray-applying a threat-diminishing barrier coating of the types generally mentioned above to the outside of an elongate, exposed, ground-following petroleum-product pipeline. This methodology includes the steps of (a) straddling the pipeline with a ground-traveling, spray-coating apparatus, (b) advancing the spray-coating apparatus progressively along an elongate stretch of that pipeline, and (c) in relation to such advancing, spray coating the outside of the subject pipeline with the desired threat-diminishing barrier coating material.

These and other features and obvious advantages of the present invention will now become more fully apparent as the description which follows is read in conjunction with the accompanying drawings.

### DESCRIPTION OF THE DRAWINGS

FIG. 1 is a simplified and schematic plan view of a non-straight-linear oil (petroleum-product) pipeline with respect to which a straddle-coater made in accordance with the present invention is illustrated in several positions to represent progressive movement of the straddle-coater along the illustrated pipeline. As will become apparent from the description of the invention which follows below, FIG. 1 is employed herein to illustrate several modifications of the methodology and structure of the present invention.

FIG. 2 is a somewhat enlarged side elevation taken generally along the line 2-2 in FIG. 1.

FIG. 3 is a side elevation taken generally along the line 3-3 in FIG. 2.

FIG. 4 is an even larger-scale, fragmentary, cross-sectional view illustrating a portion of a self-sealing, anti-puncture-leak, anti-ballistic barrier coating which has been sprayed onto the outside of the pipeline shown in FIGS. 1-3, inclusive.

FIGS. 2, 3 and 4 include fragmentary illustrations of one form of a protective barrier coating created by the straddle-coater of the present invention.

FIG. 5 is similar to FIG. 4, with the exception that shown here is one additional overlayer in a barrier coating which functions as a fire-suppression layer.

### DETAILED DESCRIPTION OF THE INVENTION

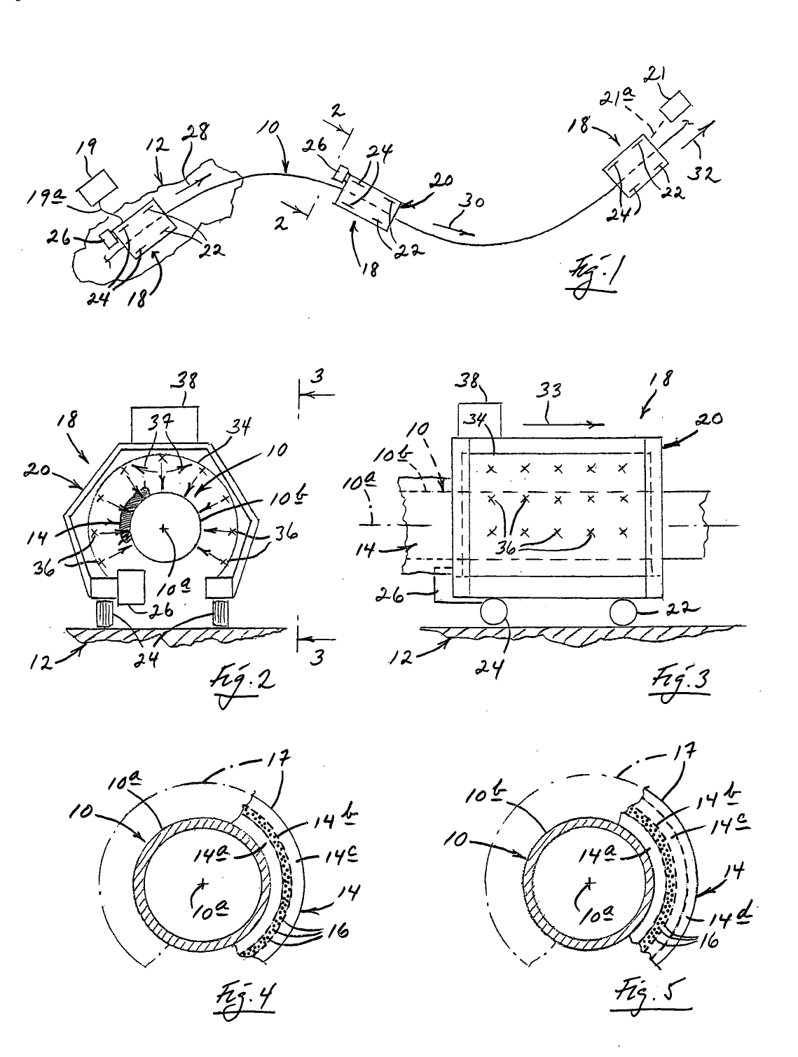

Turning now to the drawings, and referring first of all to FIGS. 1-4, inclusive, an elongate oil (petroleum-product) pipeline which is to be coated and protected with an anti-ballistic, threat-diminishing barrier coating in accordance with practice of the present invention, is shown very generally at 10. Pipeline 10 is an above-ground, fixed-in-place, ground-following structure having, for illustration purposes herein, an outside diameter of about 48-inches. Pipeline 10 is suitably supported with its central axis 10a disposed about 60-inches above the surface level of the ground which is shown fragmentarily at 12. Pipeline 10 has exposed outer wall 10b. Conventional pipelines, like pipeline 10, might typically have an outside diameter lying in the range of about 12-inches to about 72-inches.

Pipeline 10 herein carries flammable crude petroleum, or oil, though it could just as well carry some other flammable, petroleum-product liquid which is “at risk” for combusting openly and dangerously if an uncontrolled puncture leak occurs from a breach in the wall of the pipeline. It should also be understood that the term “pipeline” as used herein, is intended to refer to any above-ground, ground-supported, ground-following, elongate, petroleum-product-carrying (or the like) structure generally like pipeline 10. In particular, this term is intended to encompass such an elongate, exposed structure which can be straddled and followed laterally along its length. Representative oil pipeline 10, as pictured schematically in FIG. 1, is illustrated fragmentarily, and as a single line, possessing an exaggerated sinuous, or serpentine, wandering characteristic. This has been done simply to make an important point about the ability of the present invention to perform its line-coating task on pipeline-like structures which are not necessarily straight-linear (i.e., non-straight-linear).

Illustrative reasons for applying a protective, self-sealing, anti-ballistic, anti-leak coating, with or without an overlayered fire-suppression coating, to the outside of the outer wall in pipeline 10 have been mentioned earlier herein. FIGS. 2, 3, and 4 picture fragmentarily at 14, on the outer side of wall 1Ob in pipeline 10, one very useful form of a self-sealing, anti-puncture-leak, anti-ballistic, threat-diminishing barrier coating which has been applied in accordance with practice of the present invention. In FIG. 2, the fragmentary showing of coating 14 is shaded in order to make it more visible in this view. FIG. 5 shows, also fragmentarily, a modified coating 14 which, as will later be explained, includes a fire-suppression overlayer.

Self-sealing, anti-puncture-leak coating 14, as shown in FIGS. 2, 3 and 4, details of which are more fully described immediately below herein, has an overall thickness of about 1 and ¼ inches, and includes integrated inner, intermediate and outer layers 14a, 14b, 14c, respectively (see FIG. 4). This coating thickness is exaggerated herein for better visibility purposes.

Layers 14a, 14c are formed herein solely of a petroleum-reactive, high-elastomeric, material such as the two-part, blendable product sold under the trademark TUFF STUFF ® (FR made by Rhino Linings USA, Inc. in San Diego, Calif. Specific product designations of this product which are quite satisfactory are Rhino-Linings product component numbers 60012 and 60058. Layer 14b is formed as a composite assembly including the same high-elastomeric material employed in layers 14a, 14c, along with a distribution therein of embedded, petroleum-reactive, liquid-imbiber beads 16, such as the beads made by Imbibitive Technologies America, Inc. in Midland, Mich., product-designated IMB230300. In layer 14b, beads 16 make up about 30% by weight of the whole layer. While different, specific layer thicknesses may be employed within coating 14, layer 14a herein has a thickness of about ½ inches, layer 14b a thickness of about ¼ inches and layer 14c a thickness of about ½ inches. These thicknesses have been found to be suitable where internal pipeline pressure is approximately about 50-psi or lower. Greater per-layer thicknesses, with relative layer thicknesses remaining similarly proportioned, are more appropriate to deal with higher-level, internal pipeline pressures. Based on the invention description now being given herein, overall coating-thickness choice is recognized to be well within the skill levels of those generally skilled in the relevant art. The materials making up coating layers 14a, 14b, 14c are referred to herein collectively as self-sealing, anti-puncture-leak coating material.

Both the high-elastomeric material and the liquid-imbiber beads used in coating 14 have, as intentionally selected for them by the present pipeline-coating application, a reactive affinity for, and with respect to, petroleum products, such as crude oil, in that they (a) absorb such products, (b) swell and tend to coagulate when exposed to them, as, for example, if there occurs a puncture wound in the relevant coating/protected structure (pipeline) wall, and (c) rapidly self-seal such a wound using the combined mechanisms of elasticity, swelling and coagulation.

These coating-14 materials are applied by spraying onto the outside of wall 10b in pipeline 10 to have, preferably, a nearly full, pipeline-axial-circumsurrounding relationship on this wall, with respect to pipeline axis 10a as seen in FIG. 4 in combined solid and dash-dot lines 17.

A traveling pipeline straddle-coater, also referred to herein as ground-traveling, spray-coating apparatus, which is employed in the spray-coating practice of the present invention is shown generally, and in very simple, schematic form, at 18 in FIGS. 1-3, inclusive. Those who are generally skilled in the relevant art will immediately recognize, from the invention description which now follows below, that the details of construction of straddle-coater 18 form no part of the present invention, and that appropriate structural features of this straddle-coater may specifically be constructed in many different conventional-approach ways. Accordingly, no such details are presented herein so that the high-level, core features of the invention can gain better focus.

For illustration-economy herein, three different structural versions, and respective associated methodologies, are illustrated in FIG. 1 with respect to straddle-coater 18. As this straddle-coater is pictured on the left side in FIG. 1, it is a self-propelled vehicle, not quite fully self-contained, and is accompanied in its travel along pipeline 10 by an auxiliary vehicle 19, tethered to the straddle-coater by a supply tether 19a1, and whose function will be described shortly. Laterally in the center of FIG. 1, straddle-coater 18 is pictured as a self-propelled and fully self-contained vehicle. On the right side of FIG. 1, a third embodiment is illustrated, wherein motive power for propelling (by towing) the straddle-coater of the invention along pipeline 10 is supplied via an external drive vehicle, or motion-producing instrumentality, which is illustrated at 21. Vehicle 21 is drivingly coupled to the straddle-coater by a suitable towing drive connection which is illustrated by dashed line 21a in FIG.1. This third straddle-coater embodiment, like the one which was second mentioned, is also, except for motive power (vehicle 21), fully self-contained.

Continuing now a description of just one of the straddle-coater embodiments, and of the associated methodology of the present invention, focus is now directed to the central illustration of straddle-coater 18 in FIG. 1. Here, viewing FIGS. 2 and 3 along with FIG. 1, one can see that straddle-coater 18 includes an appropriate straddle frame 20 which is supported for travel over the ground by wheels, such as front and rear wheels 22, 24, respectively, which are also referred to herein as ground-traveling support structure. Front wheels 22 are made to be appropriately steerable, so as to accommodate laterally and bidirectionally steerable control and travel of straddle-coater 18 along pipeline 10.

In the particular form of straddle-coater 18 illustrated in FIGS. 1-3, inclusive, rear wheels 24 are power-driven by an appropriate engine, also referred to herein as a motion-producing instrumentality, represented in block form very schematically at 26, near the rear of frame 20 in FIGS. 1, 2 and 3. Thus, the embodiment of straddle-coater 18 now being described is, as was just mentioned above, a self-propelled vehicle. It is controlled for movement over the ground in any suitable manner. It may be controlled, for example, by a person to riding with the straddle-coater, by personnel who ride alongside it, and/or to some, or a full, extent, by a properly programmed, on-board digital computer.

Straddle-coater 18 herein is, as was just stated above, appropriately laterally and bi-directionally steerable, thus to accommodate appropriate travel with ease along a path over the ground which follows the long axis of a pipeline, such as long axis 10a in pipeline 10, even though this axis is wavy and wandering as illustrated in FIG. 1. Forward-motion travel of straddle-coater 18 along pipeline 10 is pictured generally in FIG. 1 by arrows 28, 30, 32, and in FIG. 3 by an arrow 33. Travel progress may take one of the continuous-motion travel (travel action).

It should be understood that, while self-propulsion is herein illustrated and described for the centrally pictured straddle-coater in FIG. 1, this straddle-coater could be moved in other appropriate manners, as, for example, by towing as illustrated for straddle-coater 18 as shown at the right side of FIG. 1. The straddle-coater pictured at the left side of FIG. 1 is also self-propelled.

Further included in straddle-coater 18, and suitably mounted on straddle frame 20 which is clearance-positionable over pipeline 10 as shown in FIG. 1, is an over-arching canopy, or canopy structure, 34, within which are deployed an appropriate, user-selectable array of suitable spray nozzles, such as the several nozzles shown (schematically only) at 36 by small cross marks in FIGS. 2 and 3. These spray nozzles are also referred to herein as barrier-coating spray structure. Canopy 34 is also referred to herein as being a tunnel-shroud covering.

Nozzles 36 are arrayed in an appropriate fashion inside canopy 34 so as to enable the spray-creation of coating 14 to have the pipeline-nearly-circumsurrounding condition mentioned above herein, and seen generally in FIGS. 2, 4 and 5. This nozzle array arrangement is freely a matter of user choice and preference. If desired, the nozzles may be mounted within canopy 34, on straddle frame 20, for controlled articulation so as to enable, for example, side-to-side, up-and-down, and angular changing of their respective spray directions. Curved arrows 37 in FIG. 2 suggest such articulation.

Nozzles 36 are coupled through suitable conduits (not specifically shown), and valves (also not specifically shown), to appropriately controlled pressurized supplies of the constituents from which the coating layers in coating 14 are to be formed. A block 38 in FIGS. 2 and 3 generally represents layer-material supplies, and spray-control apparatus, all of which may be of entirely conventional construction.

In the structural embodiment of a straddle-coater shown at the left side of FIG. 1, supply tether 19a supplies spray coating materials to the nozzles in this straddle-coater from auxiliary vehicle 19.

Spraying for coating-layer formation on pipeline 10 may conveniently be performed in typical daytime and nighttime ambient temperatures, and fully in accordance with practices outlined by the respective manufacturers of the coating constituent materials. Specific spray-operational practices, therefore, may be entirely conventional, and thus are not detailed herein. Control over spray operation may be provided by a human operator, and/or by an appropriately programmed digital computer. Replenishment reservoirs of coating constituent materials may be carried entirely an a self contained fashion on board the structure so far described, or such reservoirs may be provided in an auxiliary piece of traveling equipment, such as in previously mentioned auxiliary vehicle 19, which effectively follows straddle-coater 18 as it moves along the course of pipeline 10.

As was mentioned earlier, coating spraying may be accomplished in a start-stop manner of operation for straddle-coater 18, or in a continuous travel mode for the straddle-coater. Obviously, the ways in which nozzles 36 specifically deliver coating layer materials will depend on the operational mode, start-stop or continuous, chosen by a user for the straddle-coater.

Referring now specifically to FIG. 5, here, overall coating 14, which is a modification of coating 14 as shown in FIG. 4, possesses a fire-suppression overlayer 14d. This overlayer is formed herein preferably of a blend of materials, including the same high-elastomeric material identified above for use in layers 14a, 14b, 14c, and in addition, an embedded distribution of intumescence elements 40, such as an embedded distribution of sodium silicate crystals. An appropriate typical thickness for overlayer 14d might be about ⅛ inches. Preferably, such embedded crystals have a mesh size of about 100-mesh, are relatively uniformly distributed throughout overlayer 14d, and occupy this overlayer with a population which contributes about 30% to about 50% by volume of the overlayer. The materials which make up overlayer 14d are referred to herein collectively as fire-suppression coating material.

To implement the modified invention practice of including spraying of an overlayer, such as overlayer 14d, an appropriate reservoir of intumescence elements is provided.

The two versions of coating 14 function in the following manners. Layers 14a, 14b, 14c, act primarily to stop a leak of petroleum-product liquid from a pipeline when a puncture occurs. They do this utilizing mechanisms including (a) elastomeric-pressure reclosing of a puncture wound, (b) liquid imbibing and associated swelling to augment such pressure-closing of the wound, and (c) wound-closure-“welding” through coagulation and congealing of the elastomeric and imbiber-bead materials in reaction to contact with leakage liquid. Such closure minimizes the amount of leakage liquid available for combustion.

Where an overlayer 14d is present, elastomeric material therein augments the wound closure actions performed by layers 14a, 14b, 14c, and the intumescence elements embedded in this overlayer burst in the presence of the heat created by any outside-initiated fire, and in so bursting, tend positively to suppress such a fire.

With respect to implementation and practice of the spray-coating behavior of the present invention, straddle-coater 18 is, of course, appropriately sized to fit properly in a clearance straddling condition over a selected pipeline, such as pipeline 10. The straddle-coater is provided with suitable wheels, or other ground-traveling support structure, to accommodate efficient motion contact with the character of the ground topography which is followed by that pipeline. Additionally, appropriate motive power is provided for the straddle-coater, either for self-propelled driving thereof, as through rear wheels 24 shown herein, or via a selected auxiliary drive vehicle, such as via towing vehicle 19.

As the straddle-coater moves along a pipeline, in either a start-stop or continuous fashion, the length of pipeline within canopy 34 is a spray coated to produce either one of the two described coatings 14 on the outside of the pipeline. The process is remarkably efficient, and is capable of enabling rapid coating easily of very long pipelines. This process can be described as one including the steps of (a) straddling a pipeline with a ground-traveling spray-coating apparatus, (b) advancing the spray-coating apparatus progressively along an elongate stretch of that pipeline, and (c), in relation to advancing the straddle-coater along the pipeline, spray coating the outside of that pipeline.

Thus, while various forms and practices of the present invention have been illustrated and described to bring out the core features of the invention, those skilled in the art will recognize that variations and modifications of these forms and practices may be implemented if desired. It is intended that all such variations and modifications of the invention will come within the scope and spirit of the now-following claims to invention.

We claim:

1. A traveling pipeline straddle-coater for spray-applying an anti-ballistic, threat-diminishing, protective barrier coating to the outside of an elongate, ground-following petroleum-product pipeline comprising
a straddle frame which is clearance-positionable over such a pipeline,
ground-traveling support structure supporting said straddle frame for movement over the ground along the pipeline under circumstances with the straddle frame positioned over that pipeline,
canopy structure mounted on said straddle frame for tunnel-shroud covering a frame-straddled length of the pipeline, and
barrier-coating spray structure carried on said straddle frame inside said canopy structure, operable to spray barrier-coating material onto the outside of such a frame-straddled pipeline length.

2. The straddle-coater of claim 1 with respect to which the to-be-protected pipeline, as viewed from above, is non-straight-linear, and said ground-traveling support structure is steerable to accommodate lateral following of the pipeline by said straddle frame during movement thereof along the pipeline.

3. The straddle-coater of claim 1, wherein said spray structure includes articulated, spray-direction-positionable nozzles.

4. The straddle-coater of claim 1, wherein said ground-traveling support structure and said spray structure are operable in at least one of the manners including (a) continuous travel-motion action, and (b) move-stop-move travel-motion action.

5. The straddle-coater of claim 1, wherein said spray structure includes nozzles, and said nozzles collectively are designed to spray, onto the outside of a pipeline, at least (a) self-sealing, anti-puncture-leak coating material, and optionally and additionally (b) fire-suppression coating material.

6. The straddle-coater of claim 1 which further comprises a motion-producing instrumentality operatively and drivingly connected to said ground-traveling support structure, operable to move said straddle frame progressively along a to-be-protected pipeline in relation to companion operation of said spray structure to spray barrier-coating material onto the outside of the pipeline.

7. The straddle-coater of claim 6, wherein said motion-producing instrumentality and said ground-traveling support structure are operatively linked in such a manner that said straddle-coater operates as a self-propelled vehicle.

8. The straddle-coater of claim 6, wherein said motion-producing instrumentality and said ground-traveling support structure are operatively linked in such a manner that said motion-producing instrumentality is external both to said straddle frame and to said ground-traveling support structure.

9. A method of spray-applying a threat-diminishing, protective, anti-ballistic barrier coating onto the outside of an elongate, ground-following petroleum pipeline comprising
straddling the pipeline with a ground-traveling spray-coating apparatus,
advancing the spray-coating apparatus progressively along an elongate stretch of that pipeline, and
in relation to said advancing, spray coating the outside of the pipeline with protective barrier-coating material.
